(19) United States
(12) Patent Application Publication
(10) Pub. No.: US 2025/0016676 A1
(43) Pub. Date: Jan. 9, 2025

(54) WAKE-UP SIGNAL DETECTION METHOD AND DEVICE

(71) Applicant: VIVO MOBILE COMMUNICATION CO., LTD., Dongguan (CN)

(72) Inventors: Xiaodong SHEN, Dongguan (CN); Xin QU, Dongguan (CN)

(73) Assignee: VIVO MOBILE COMMUNICATION CO., LTD., Dongguan (CN)

(21) Appl. No.: 18/892,337

(22) Filed: Sep. 20, 2024

Related U.S. Application Data
(63) Continuation of application No. PCT/CN2023/082686, filed on Mar. 21, 2023.

(30) Foreign Application Priority Data
Mar. 22, 2022 (CN) 202210284378.3

(51) Int. Cl. H04W 52/02; H04W 24/08

(52) U.S. Cl. CPC H04W 52/0229; H04W 24/08

(57) ABSTRACT

This application discloses a wake-up signal detection method, a communication device, and a computer-readable storage medium. The wake-up signal detection method includes: determining, by a receiving end, a sampling rate; determining, by the receiving end, a feature sequence set matching the sampling rate from a plurality of feature sequence sets based on the sampling rate; and monitoring, by the receiving end, a wake-up signal based on a first feature sequence in the feature sequence set.

### CROSS-REFERENCE TO RELATED APPLICATIONS

This application is a continuation of International Application No. PCT/CN2023/082686, filed on Mar. 21, 2023, which claims priority to Chinese Patent Application No. 202210284378.3, filed on Mar. 22, 2022. The entire contents of each of the above-referenced applications are expressly incorporated herein by reference.

### TECHNICAL FIELD

This application pertains to the field of communication technologies, and in particular, to a wake-up signal detection method and a device. The device may include a wake-up signal detection apparatus, a terminal, and the like.

### BACKGROUND

In a process of receiving a wake-up signal, a receiving end may monitor a specific feature sequence to determine whether it is necessary to wake up. In the related art, when a receiving end adjusts receiving power consumption by changing a sampling rate, a sending end continues to transmit a feature sequence of a wake-up signal with an original length, due to the sending end does not know the sampling rate of the receiving end has changed, consequently the receiving end cannot be correctly woken up, for example, the receiving end in a low-power working mode with a reduced sampling rate cannot be easily woken up.

### SUMMARY

Embodiments of this application provide a wake-up signal detection method and a device.

According to a first aspect, a wake-up signal detection method is provided, including: determining, by a receiving end, a sampling rate; determining, by the receiving end, a feature sequence set matching the sampling rate from a plurality of feature sequence sets based on the sampling rate; and monitoring, by the receiving end, a wake-up signal based on a first feature sequence in the feature sequence set.

According to a second aspect, a wake-up signal detection apparatus is provided, including: a determining module, configured to determine a sampling rate; where the determining module is further configured to determine a feature sequence set matching the sampling rate from a plurality of feature sequence sets based on the sampling rate; and a detection module, configured to monitor a wake-up signal based on a first feature sequence in the feature sequence set.

According to a third aspect, a terminal is provided, including a processor and a memory. A program or instructions capable of running on the processor are stored in the memory. When the program or the instructions are executed by the processor, the steps of the method according to the first aspect are implemented.

According to a fourth aspect, a terminal is provided, including a processor and a communication interface, where the processor is configured to determine a sampling rate, and further configured to determine a feature sequence set matching the sampling rate from a plurality of feature sequence sets based on the sampling rate; and the communication interface is configured to monitor a wake-up signal based on a first feature sequence in the feature sequence set.

According to a fifth aspect, a wake-up signal detection system is provided, including a terminal and network-side device, where the terminal may be configured to execute the steps of the method according to the first aspect.

According to a sixth aspect, a readable storage medium is provided, where a program or instructions are stored in the readable storage medium, and when the program or the instructions are executed by a processor, the steps of the method according to the first aspect are implemented.

According to a seventh aspect, a chip is provided, where the chip includes a processor and a communication interface, the communication interface is coupled to the processor, and the processor is configured to run a program or instructions to implement the steps of the method according to the first aspect.

According to an eighth aspect, a computer program/program product is provided, where the computer program/program product is stored in a storage medium, and the computer program/program product is executed by at least one processor to implement the steps of the method according to the first aspect.

In the embodiments of this application, the receiving end determines a sampling rate, determines a feature sequence set matching the sampling rate from a plurality of feature sequence sets based on the sampling rate; and monitors a wake-up signal based on a first feature sequence in the feature sequence set. Because the receiving end can determine the feature sequence set matching the sampling rate from the plurality of feature sequence sets, it can be ensured that the receiving end can detect the wake-up signal and be correctly woken up, thus improving communication performance.

### BRIEF DESCRIPTION OF DRAWINGS

FIG. 1 is a schematic diagram of a wireless communication system according to an embodiment of this application;

FIG. 2 is a schematic flowchart of a wake-up signal detection method according to an embodiment of this application;

FIG. 3 is a schematic structural diagram of a wake-up signal detection apparatus according to an embodiment of this application;

FIG. 4 is a schematic structural diagram of a communication device according to an embodiment of this application; and

FIG. 5 is a schematic structural diagram of a terminal according to an embodiment of this application.

### DETAILED DESCRIPTION

The following clearly describes the technical solutions in the embodiments of this application with reference to the accompanying drawings in the embodiments of this application. Apparently, the described embodiments are only some rather than all of the embodiments of this application. All other embodiments obtained by persons of ordinary skill in the art based on the embodiments of this application shall fall within the protection scope of this application.

In the specification and claims of this application, the terms such as “first” and “second” are intended to distinguish between similar objects but do not necessarily indicate a specific order or sequence. It should be understood that the data used in this way is interchangeable in appropriate circumstances so that the embodiments of this application can be implemented in other orders than the order illustrated or described herein, and “first” and “second” are usually for distinguishing same-type objects but not limiting the number of objects, for example, there may be one or more first objects. In addition, “and/or” in this specification and claims indicates at least one of connected objects, and the symbol “/” generally indicates that the associated objects are in an “or” relationship.

It should be noted that techniques described in the embodiments of this application are not limited to a Long Term Evolution (LTE) or LTE-Advanced (LTE-A) system, and may also be applied to various wireless communication systems, for example, Code Division Multiple Access (CDMA), Time Division Multiple Access (TDMA), Frequency Division Multiple Access (FDMA), Orthogonal Frequency Division Multiple Access (OFDMA), Single-carrier Frequency-Division Multiple Access (SC-FDMA), and other systems. The terms “system” and “network” in the embodiments of this application are usually used interchangeably. Techniques described herein may be used in the aforementioned systems and radio technologies, and may also be used in other systems and radio technologies. In the following descriptions, a New Radio (NR) system is described for an illustration purpose, and NR terms are used in most of the following descriptions, although these technologies may also be applied to other applications than an NR system application, for example, the 6th Generation (6G) communication system.

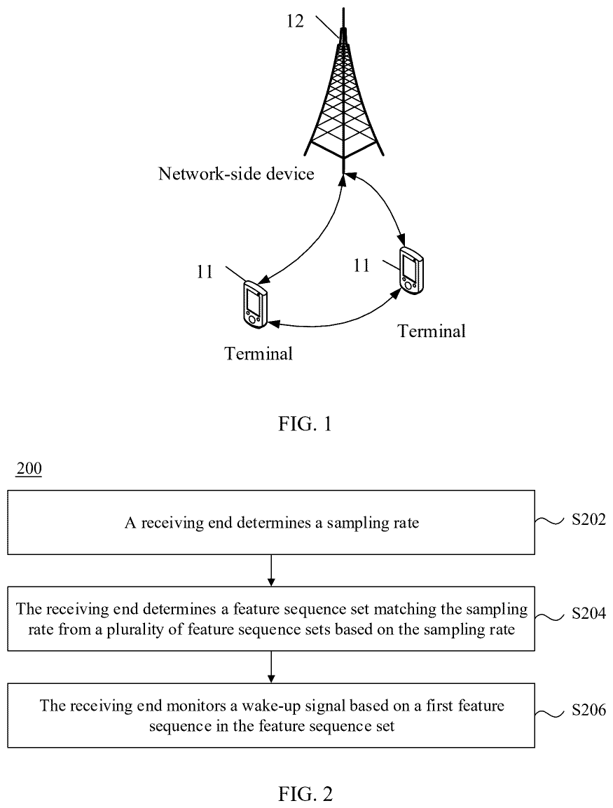

FIG. 1 is a block diagram of a wireless communication system to which the embodiments of this application are applicable. The wireless communication system includes a terminal 11 and a network-side device 12. The terminal 11 may be a terminal-side device, such as a mobile phone, a tablet computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home device (a home device with wireless communication function, such as a refrigerator, a television, a washing machine, or a furniture), a game console, a personal computer (PC), a teller machine, a self-service machine, or the like. The wearable device includes: a smart watch, a wrist band, smart earphones, smart glasses, smart jewelry (smart bracelet, smart wristband, smart ring, smart necklace, smart anklet, smart ankle bracelet, or the like), smart wristband, smart clothing, game console, and the like. It should be noted that a specific type of the terminal 11 is not limited in the embodiments of this application. The network-side device 12 may include an access network device or a core network device, where the access network device may also be referred to as a radio access network device, a Radio Access Network (RAN), a radio access network function, or a radio access network unit. The access network device may include a base station, a Wireless Local Area Network (WLAN) access point, a Wireless Fidelity (WiFi) node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a transmission and reception point (Transmission Reception Point, TRP), or another appropriate term in the art. Provided that a same technical effect is achieved, the base station is not limited to a specific technical term. It should be noted that in the embodiments of this application, the base station in the NR system is merely used as an example, and a specific type of the base station is not limited.

The following describes in detail a wake-up signal detection method provided in the embodiments of this application by using some embodiments and application scenarios thereof with reference to the accompanying drawings.

As shown in FIG. 2, an embodiment of this application provides a wake-up signal detection method 200. The method may be executed by a terminal. In other words, the method may be executed by software or hardware installed in the terminal. The method includes the following steps.
S202: A receiving end determines a sampling rate.

In some embodiments, that the receiving end (such as a terminal) determines the sampling rate includes: the receiving terminal determines the sampling rate from a sampling rate set; where the sampling rate set includes a plurality of sampling rates.

In this embodiment, the receiving end may select the sampling rate according to a reception requirement, such as a sensitivity requirement and a power consumption requirement. Certainly, the receiving end may, for example, determine the sampling rate in other ways, for example, determining the sampling rate according to an indication of the sending end (such as a network-side device). In this example, the sending end may directly indicate the sampling rate.

In some embodiments, that the receiving end determines the sampling rate from the sampling rate set includes that the receiving end determines the sampling rate from the sampling rate set based on at least one of the following:
1) Receiving sensitivity of the receiving end. For example, a higher receiving sensitivity indicates a higher sampling rate to be selected by the receiving end, which helps improve the receiving sensitivity; conversely, a lower receiving sensitivity indicates a lower sampling rate to be selected by the receiving end, which helps reduce the power consumption of the receiving end.
2) Strength of a signal received by the receiving end. For example, a weaker strength of the received signal indicates that the receiving end may be located at the edge of a cell or interference is severe and that the receiving end selects a higher sampling rate, which helps improve reception quality; conversely, a larger strength of the received signal indicates that the receiving end selects a lower sampling rate, which helps reduce power consumption of the receiving end.
3) Quality of a beacon signal received by the receiving end. For example, a poorer quality of the received beacon signal indicates that the receiving end may be located at the edge of the cell or the interference is severe and that the receiving end selects a higher sampling rate, which helps improve reception quality; conversely, a better quality of the received beacon signal indicates that the receiving end selects a lower sampling rate, which helps reduce power consumption of the receiving end.
4) Power consumption requirement. For example, a higher power consumption requirement indicates that the receiving end selects a lower sampling rate, which helps reduce the power consumption of the receiving end; conversely, a lower power consumption requirement or no power consumption requirement indicates that the receiving end selects a higher sampling rate, which helps improve the reception quality.

In some embodiments, the sampling rate in the sampling rate set is a divisor (approximate divisor) or multiple (approximate multiple) of a sampling rate used for sending a wake-up signal by the sending end, so that the sampling rate determined by the receiving end from the sampling rate set may meet at least one of the following requirements: 1) advance agreement is not required between the receiving end and the sending end; 2) no notification from the sending end is required; and 3) the receiving end does not need to notify the sending end.
S204: The receiving end determines a feature sequence set matching the sampling rate from a plurality of feature sequence sets based on the sampling rate.

In some embodiments, feature sequences included in the plurality of feature sequence sets have different lengths, for example, the plurality of feature sequence sets are feature sequence set 1, feature sequence set 2 and feature sequence set 3. The feature sequence set 1 includes a plurality of feature sequences with a length of 16, the feature sequence set 2 includes a plurality of feature sequences with a length of 8, and the feature sequence set 3 includes a plurality of feature sequences with a length of 4.

In some embodiments, the plurality of feature sequence sets respectively correspond to different sampling rates. In this embodiment, for example, the sampling rate determined by the terminal may be positively correlated with the length of the feature sequence included in the feature sequence set. For example, when the sampling rate determined by the terminal is s₁, the terminal determines the feature sequence set 1 in this step; when the sampling rate determined by the terminal is s₂, the terminal determines the feature sequence set 2 in this step; and when the sampling rate determined by the terminal is s₃, the terminal determines the feature sequence set 3 in this step; where s₁>S₂>S₃.

In some embodiments, each feature sequence set in the plurality of feature sequence sets includes a plurality of feature sequences, where each feature sequence in the plurality of feature sequences meets a requirement of maximizing a peak-to-side lobe ratio or a requirement of minimizing a maximum sidelobe value. In this embodiment, each feature sequence meets the requirement of maximizing the peak-to-side lobe ratio or the requirement of minimizing the maximum sidelobe value, that is, for the receiving end, the wake-up signal may be correctly detected by using a specified feature sequence in any one of the plurality of feature sequence sets.
S206: The receiving end monitors a wake-up signal based on a first feature sequence in the feature sequence set.

In this step, the receiving end may monitor the wake-up signal based on the first feature sequence and the sampling rate determined in S202.

In some embodiments, before S206, the method further includes: the receiving end determines the first feature sequence from the feature sequence set based on a feature value.

In some embodiments, the feature value is determined according to one of the following: 1) being determined by the receiving end based on identification information of the receiving end; and 2) being indicated by a sending end.

In the wake-up signal detection method provided in this embodiment of this application, the receiving end determines the sampling rate, determines the feature sequence set matching with the sampling rate from a plurality of feature sequence sets based on the sampling rate, and monitors the wake-up signal based on the first feature sequence in the feature sequence set. The receiving end can determine the feature sequence set matching with the sampling rate from the plurality of feature sequence sets, which helps the receiving end to detect the wake-up signal so as to be correctly woken up, thus improving the communication performance.

The following describes in detail the wake-up signal detection method provided in this embodiment of this application with reference to several specific embodiments.

### Embodiment 1

An embodiment of this application provides a wake-up signal detection method, so that the receiving end may implement compatibility of multi-sampling rate and low power consumption, and this embodiment includes the following steps.
Step 1: The receiving end uses one sampling rate sᵢ in a sampling rate set S={sᵢ|s₀, s₁, s₂, . . . } to perform sampling on received signals.

In some embodiments, the sampling rate used by the receiving end does not need to be agreed between the receiving end and the sending end in advance, or the sending end does not need to notify the receiving end in advance.

In some embodiments, the receiving end may determine, according to its own judgment, which sampling rate to be used, for example, determining the sampling rate based on one or more of the following conditions: receiving sensitivity; a strength of a received signal; and quality of a received beacon signal (beacon or Keep-alive).
Step 2: The receiving end determines, based on the currently used sampling rate sᵢ, one feature sequence set Mᵢ from a feature sequence set group M={Mᵢ|M₀, M₁, M₂, . . . }, where Mᵢ={M_{i,j}|M_{i,0}, M_{i,1}, M_{i,2}, . . . } and M_{i,j} is a feature sequence.

The feature sequence set group includes a plurality of feature sequence sets corresponding to the plurality of feature sequence sets described in S204.
Step 3: The receiving end determines a feature value q.

In this embodiment, for example, the receiving end determines the feature value based on its own terminal identification (User Equipment_Identity Document, UE_ID), where for the feature value, refer to serial numbers in the first column in Table 1 below.

In this embodiment, for nother example, the receiving end is a terminal, and the feature value is pre-assigned by the network-side device.
Step 4: The receiving end determines, based on the feature value q, one feature sequence M_{i,q} from Mᵢ={M_{i,j}|M_{i,0}, M_{i,1}, M_{i,2}, . . . }.
Step 5: The receiving end monitors a wake-up signal based on the feature sequence M_{i,q}.

It can be understood that in this step, the receiving end may monitor the wake-up signal based on the feature sequence M_{i,q} and the sampling rate sᵢ determined in step 1.

### Embodiment 2

This embodiment may be combined with Embodiment 1, and this instance is mainly a detailed description of some details in Embodiment 1.

In this embodiment, the network-side device may assign a feature value q to the receiving end, and the receiving end (terminal) may determine, according to the receiving requirement such as sensitivity and power consumption, whether to select the following M_{16,j}, M_{8,j} or M_{4,j} to monitor the wake-up signal.

M_{16,j}, M_{8,j} or M_{4,j} are predefined sequences, which are used for different sampling rates respectively.

The sending end (such as the network-side device) may send the sequences based on a predefined sampling rate, for example, always making combination based on a feature sequence corresponding to a maximum sampling rate (M_{16,j} in the following table); and the receiving end can correctly detect the wake-up signal regardless of whether M_{16,j}, M_{8,j} or M_{4,j} is used.

When sampling is performed at a downsampling rate here, a sampling manner or an energy accumulation manner may be selected.

For example, when the sampling manner is adopted, in a case that the sampling rate is half of the original, sample values of original even-numbered or odd-numbered sampling points are sampled (as shown in Table 3). When the energy accumulation manner is used, in a case that the sampling rate is half of the original, an amplitude value of each sample point after downsampling may be determined based on a multi-amplitude value (as shown in Tables 1 and 2).

As mentioned above, the wake-up signal can be correctly detected by the receiving end regardless of whether M_{16,j}, M_{8,j} or M_{4,j} is used. The following provides description by using a row with the serial number 1 in Table 1 (sampling is performed in an energy accumulation manner) as an example.

If the sending end sends a wake-up signal based on M_{16,j}, namely, a feature sequence 1 of 0000011001101011:

Assuming that the receiving end performs monitoring based on M_{16,j}, namely, a feature sequence 1 of 0000011001101011, it is obvious that the wake-up signal can be detected.

Assuming that the receiving end performs monitoring based on M_{8,j}, namely, a feature sequence 2 of 00111112, every two bits in the feature sequence 1 may correspond to one bit in the feature sequence 2. For example, the first two bits 00 in the feature sequence 1 correspond to the first bit 0 in the feature sequence 2; the third and fourth bits 00 in the feature sequence 1 correspond to the second bit 0 in the feature sequence 2; the fifth and sixth bits 01 in the feature sequence 1 correspond to the third bit 1 in the feature sequence 2; . . . . In this way, the receiving end can correctly detect the wake-up signal.

Assuming that the receiving end performs monitoring based on M_{4,j}, namely, a feature sequence 3 of 0223, every four bits in the feature sequence 1 may correspond to one bit in the feature sequence 3. For example, the first four bits 0000 in the feature sequence 1 correspond to the first bit 0 in the feature sequence 3; the fifth to eighth bits 0110 in the feature sequence 1 correspond to the second bit 2 in the feature sequence 3; the ninth to twelfth bits 0110 in the feature sequence 1 correspond to the third bit 2 in the feature sequence 3; . . . . In this way, the receiving end can correctly detect the wake-up signal.

In addition, the feature sequence set groups shown in Table 1, Table 2 or Table 3 may be predefined, for example, being specified in the protocol; or may be configured by the sending end for the receiving end. For example, the sending end may configure the feature sequence set group including multiple rows and columns shown in Table 1 for the receiving end. For another example, based on the feature value of the receiving end, the sending end merely configures a feature sequence set group of a specific row for the receiving end, where the feature sequence set group includes a plurality of feature sequences with different lengths. For example, based on the feature value 1 of the receiving end, the sending end merely configures for the receiving end a feature sequence similar to 0000011001101011; and based on 0000011001101011, the receiving end may independently determine the feature sequence 00111112 corresponding to M_{8,j} and the feature sequence 0223 corresponding to M_{4,j}.

As mentioned above, the wake-up signal can be correctly detected by the receiving end regardless of whether M_{16,j}, M_{8,j} or M_{4,j} is used. The following provides description by using a row with the serial number 1 in Table 3 (sampling is performed in a sampling manner) as an example.

If the sending end sends a wake-up signal based on M_{23,j}, namely, a feature sequence 1 of 00111000000101011011011:

Assuming that the receiving end performs monitoring based on M_{23,j}, namely, a feature sequence 1 of 00111000000101011011011, it is obvious that the wake-up signal can be detected.

Assuming that the receiving end monitors a wake-up signal based on M_{11,j}, namely, a feature sequence 2 of 01000111011, each even-numbered bit in the feature sequence 1 may correspond to one bit in the feature sequence 2. For example, the second bit in the feature sequence 1 corresponds to the first bit in the feature sequence 2; the fourth bit in the feature sequence 1 corresponds to the second bit in the feature sequence 2; . . . . In this way, the receiving end can correctly detect the wake-up signal.

Assuming that the receiving end monitors a wake-up signal based on M_{6,jj}, namely, a feature sequence 3 of 000101, the 2nd, 6th, 10th, 14th, 18th, and 22nd bits in the feature sequence 1 correspond to the 1st, 2nd, 3rd, 4th, 5th, and 6th bits in the feature sequence 3 respectively. That is, every four bits in the feature sequence 1 correspond to one bit in the feature sequence 3. In this way, the receiving end can correctly detect the wake-up signal.

TABLE 1
Feature sequence set groups with lengths (16, 8, 4)
(monitoring in an energy accumulation manner)

| Serial | | | |
|---|---|---|---|
| number | | | |
| q | M_{16,j} | M_{8,j} | M_{4,j} |
| 1 | ′0000011001101011′ | ′00111112′ | ′0223′ |
| 2 | ′0000111011101101′ | ′00212121′ | ′0333′ |
| 3 | ′0001000111101001′ | ′01012111′ | ′1132′ |
| 4 | ′0001110111011010′ | ′01212111′ | ′1332′ |
| 5 | ′0010100110011111′ | ′01111122′ | ′1224′ |
| 6 | ′0011110100100010′ | 02210101′ | ′2311′ |
| 7 | ′0100010010111100′ | ′10101220′ | ′1132′ |
| 8 | ′0100100010001111′ | ′10101022′ | ′1114′ |
| 9 | ′0101001100111110′ | ′11020221′ | ′2223′ |
| 10 | ′0101101110111000′ | ′11121210′ | ′2331′ |
| 11 | ′0110100001110111′ | ′11101212′ | ′2133′ |
| 12 | ′0111110011001010′ | ′12202011′ | ′3222′ |
| 13 | ′1000001100110101′ | ′10020211′ | ′1222′ |
| 14 | ′1001011110001000′ | ′11121010′ | ′2311′ |
| 15 | ′1010010001000111′ | ′11101012′ | ′2113′ |
| 16 | ′1010110011000001′ | ′11202001′ | ′2221′ |
| 17 | ′1011011101110000′ | ′12121200′ | ′3330′ |
| 18 | ′1011101101000011′ | ′12121002′ | ′3312′ |
| 19 | ′1100001011011101′ | ′20012121′ | ′2133′ |
| 20 | ′1101011001100000′ | ′21111100′ | ′3220′ |
| 21 | ′1110001000100101′ | ′21010111′ | ′3112′ |
| 22 | ′1110111000010110′ | ′21210111′ | ′3312′ |
| 23 | ′1111000100010010′ | ′22010101′ | ′4111′ |
| 24 | ′1111100110010100′ | ′22111110′ | ′4221′ |

TABLE 2
Feature sequence set groups with lengths (24, 12, 6)
(monitoring in an energy accumulation manner)

| Serial | | | |
|---|---|---|---|
| number | | | |
| q | M_{24,j} | M_{12,j} | M_{6,j} |
| 1 | ′001100011111101010110110′ | ′020122111211′ | ′214232′ |
| 2 | ′001110000000101011011001′ | ′021000112111′ | ′210232′ |
| 3 | ′011001001010111111100011′ | ′111011222102′ | ′212432′ |
| 4 | ′011011010101111110001100′ | ′112111221020′ | ′232412′ |
| 5 | ′100100101010000001110011′ | ′110111001202′ | ′212032′ |
| 6 | ′100110110101000000011100′ | ′111211000120′ | ′232012′ |
| 7 | ′110001111111010100100110′ | ′201222110111′ | ′234212′ |
| 8 | ′110011100000010101001001′ | ′202100111011′ | 230212′ |

TABLE 3
Feature sequence set groups with lengths (23, 11, 6)
(monitoring in a sampling manner)

| Serial | | | |
|---|---|---|---|
| number | | | |
| q | M_{23,j} | M_{11,j} | M_{6,j} |
| 1 | 00111000000101011011011 | 01000111011 | 000101 |
| 2 | 10010010101111110001110 | 01000111011 | 000101 |
| 3 | 00100100101011111100011 | 00100011101 | 010111 |
| 4 | 11011011010100000011100 | 11011100010 | 101000 |
| 5 | 01101101010000001110001 | 10111000100 | 111010 |
| 6 | 01110001111110101001001 | 11011100010 | 101000 |
| 7 | 11000111111010100100100 | 10111000100 | 111010 |

### Embodiment 3

This embodiment may be combined with Embodiment 1, and this instance is mainly a detailed description of some details in Embodiment 1.

In this embodiment, the feature sequences in Mᵢ={M_{i,j}|M_{i,0}, M_{i,1}, M_{i,2}, . . . } meet some characteristics to improve robustness of monitoring, for example, meeting the requirement of maximizing a peak-to-side lobe ratio or the requirement of minimizing a maximum sidelobe value.
(1) Meeting the requirement of maximizing a peak-to-side lobe ratio.

For the receiving end based on signal energy monitoring, the peak-to-side lobe ratio may be obtained based on the following formula: considering one binary sequence α₁, α₁, . . . α_{N}, the peak-to-side lobe ratio F may be defined as:

$$F = \frac{{N}^{2}}{2 {\sum }_{i = 1}^{N - 1} {γ}_{i}^{2}} ,$$

where
γᵢ=Σₖ₌ᵢ₊₁^{N}αₖαₖ₋ᵢ, i=1, 2, . . . , N−1; and N is the length of the feature sequence.

The method of minimizing a maximum sidelobe value is to meet a requirement that the maximum sidelobe value is the smallest.

The receiving end that performs monitoring based on signal energy may select the method of minimizing a maximum sidelobe value from all possible sequences, which may be obtained based on the following formula: considering one binary sequence α₁, α₁, . . . α_{N}, the maximum sidelobe value may be defined as:

maxᵢ|γᵢ|, where
γᵢ=Σₖ₌ᵢ₊₁^{N}αₖαₖ₋ᵢ, i=1, 2, . . . , N−1, and N is the length of the feature sequence.

The wake-up signal detection method provided in the embodiments of this application may be executed by a wake-up signal detection apparatus. In this embodiment of this application, the wake-up signal detection method being performed by the wake-up signal detection apparatus is used as an example to describe the wake-up signal detection apparatus provided in the embodiments of this application.

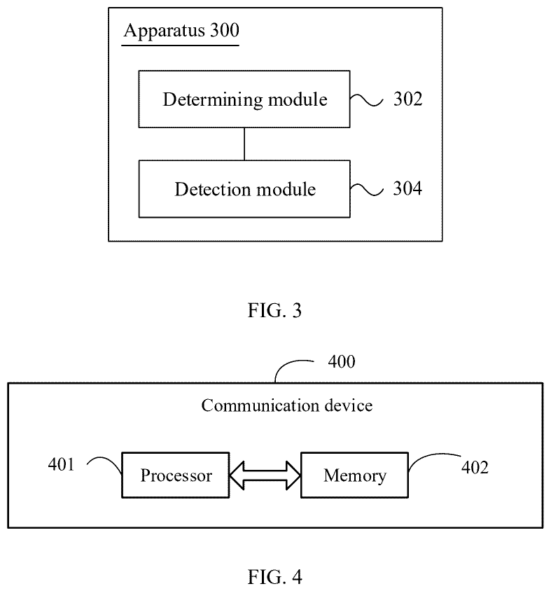

FIG. 3 is a schematic structural diagram of a wake-up signal detection apparatus according to an embodiment of this application. The apparatus may correspond to the receive end, such as a terminal, in other embodiments. As shown in FIG. 3, the apparatus 300 includes the following modules:
a determining module 302 configured to determine a sampling rate, where
the determining module 302 is further configured to determine a feature sequence set matching the sampling rate from a plurality of feature sequence sets based on the sampling rate; and
a detection module 304 configured to monitor a wake-up signal based on a first feature sequence in the feature sequence set.

According to the wake-up signal detection apparatus provided in this embodiment of this application, the determining module determines the sampling rate, and determines the feature sequence set matching with the sampling rate from a plurality of feature sequence sets based on the sampling rate; and the detection module monitors the wake-up signal based on the first feature sequence in the feature sequence set. The feature sequence set matching with the sampling rate can be determined from the plurality of feature sequence sets, which helps the receiving end to detect the wake-up signal so as to be correctly woken up, thus improving the communication performance.

In some embodiments, in an embodiment, the feature sequence set includes a plurality of feature sequences, and each feature sequence in the plurality of feature sequences meets a requirement of maximizing a peak-to-sidelobe ratio or a requirement of minimizing a maximum sidelobe value.

In some embodiments, in an embodiment, the plurality of feature sequence sets respectively correspond to different sampling rates.

In some embodiments, in an embodiment, the determining module 302 is configured to determine the sampling rate from a sampling rate set, where the sampling rate set includes a plurality of sampling rates.

In some embodiments, in an embodiment, the determining module 302 is configured to determine the sampling rate from the sampling rate set based on at least one of the following: 1) receiving sensitivity of the apparatus; 2) strength of a signal received by the apparatus; 3) quality of a beacon signal received by the apparatus; and 4) a power consumption requirement.

In some embodiments, in an embodiment, the sampling rate in the sampling rate set is a divisor or multiple of a sampling rate used for sending a wake-up signal by the sending end, so that the sampling rate determined by the determining module from the sampling rate set may meet at least one of the following requirements: 1) advance agreement is not required between the apparatus and the sending end; 2) no notification from the sending end is required; and 3) the apparatus does not need to notify the sending end.

In some embodiments, in an embodiment, the determining module 302 is further configured to determine the first feature sequence from the feature sequence set based on a feature value.

In some embodiments, in an embodiment, the feature value is determined according to one of the following: 1) being determined by the apparatus based on identification information of the apparatus; and 2) being indicated by a sending end.

For the apparatus 300 in this embodiment of this application, refer to the processes of the method 200 in the corresponding embodiments of the this application, and the units or modules of the apparatus 300 and other operations and/or functions described above are used to implement the corresponding processes in the method 200, with the same or equivalent technical effects achieved. For brevity, details are not repeated herein.

The wake-up signal detection apparatus in this embodiment of this application may be an electronic device, such as an electronic device with an operating system, or a component in the electronic device, such as an integrated circuit or a chip. The electronic device may be a terminal or other devices than the terminal. For example, the terminal may include, but is not limited to, the types of the terminal 11 listed above, and other devices may be a server, a Network Attached Storage (NAS), and the like. This is not limited in the embodiment of this application.

The wake-up signal detection apparatus provided in this embodiment of this application is capable of implementing the processes implemented in the method embodiments in FIG. 2, with the same technical effects achieved. To avoid repetition, details are not described herein again.

In some embodiments, as shown in FIG. 4, an embodiment of this application further provides a communication device 400, including a processor 401 and a memory 402. A program or instructions capable of running on the processor 401 are stored in the memory 402. For example, when the communication device 400 is terminal, and when the program or the instructions are executed by the processor 401, the steps of the foregoing wake-up signal detection method embodiments are implemented, with the same technical effects achieved. To avoid repetition, details are not described herein again.

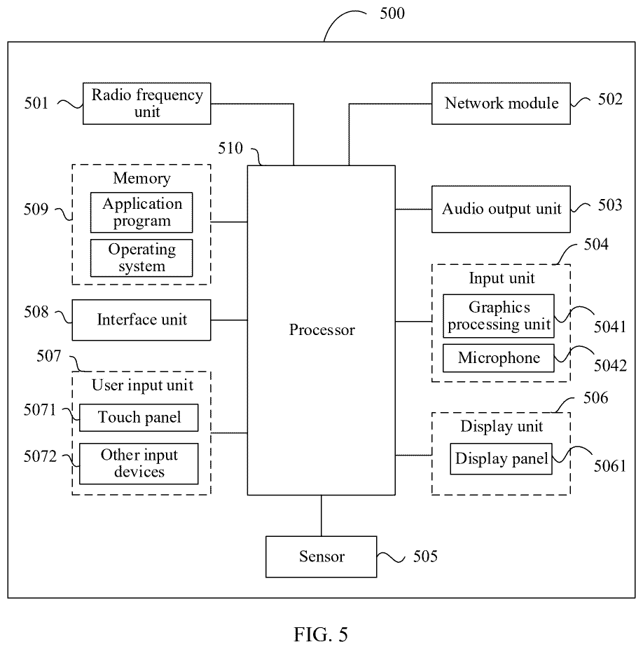

An embodiment of this application further provides a terminal, including a processor and a communication interface, where the processor is configured to determine a sampling rate, and further configured to determine a feature sequence set matching the sampling rate from a plurality of feature sequence sets based on the sampling rate; and the communication interface is configured to monitor a wake-up signal based on a first feature sequence in the feature sequence set. The terminal embodiments correspond to the foregoing terminal-side method embodiments, and the implementation processes and implementations of the foregoing method embodiments can be applied to the terminal embodiments, with the same technical effects achieved. Specifically, FIG. 5 is a schematic diagram of a hardware structure of a terminal for implementing the embodiments of this application.

The terminal 500 includes but is not limited to at least part of components such as a radio frequency unit 501, a network module 502, an audio output unit 503, an input unit 504, a sensor 505, a display unit 506, a user input unit 507, an interface unit 508, a memory 509, and a processor 510.

Persons skilled in the art can understand that the terminal 500 may further include a power supply (for example, a battery) supplying power to the components, and the power supply may be logically connected to the processor 510 through a power management system. In this way, functions such as charge management, discharge management, and power consumption management are implemented by using the power management system. The structure of the terminal shown in FIG. 5 does not constitute any limitation on the terminal. The terminal may include more or fewer components than shown in the figure, or a combination of some components, or the components disposed differently. Details are not described herein again.

It can be understood that in this embodiment of this application, the input unit 504 may include a Graphics Processing Unit (GPU) 5041 and a microphone 5042. The graphics processing unit 5041 processes image data of a still picture or video obtained by an image capture apparatus (such as a camera) in a video capture mode or an image capture mode. The display unit 506 may include a display panel 5061, and the display panel 5061 may be configured in a form of a liquid crystal display, an organic light-emitting diode, and the like. The user input unit 507 may include at least one of a touch panel 5071 and other input devices 5072. The touch panel 5071 is also referred to as a touchscreen. The touch panel 5071 may include two parts: a touch detection apparatus and a touch controller. The other input devices 5072 may include but are not limited to a physical keyboard, a function key (such as a volume control key or a power on/off key), a trackball, a mouse, a joystick, and the like. Details are not described herein.

In this embodiment of this application, the radio frequency unit 501 receives downlink data from a network-side device, and then sends the downlink data to the processor 510 for processing. In addition, the radio frequency unit 501 may sends uplink data to the network-side device. Generally, the radio frequency unit 501 includes but is not limited to an antenna, an amplifier, a transceiver, a coupler, a low noise amplifier, a duplexer, and the like.

The memory 509 may be configured to store software programs or instructions and various data. The memory 509 may include a first storage area for storing a program or instructions and a second storage area for storing data. The first storage area may store an operating system, an application program or instruction required by at least one function (for example, a sound playback function or an image playback function), and the like. In addition, the memory 509 may include a volatile memory or a non-volatile memory, or the memory 509 may include both a volatile memory and a non-volatile memory. The non-volatile memory may be a Read-Only Memory (ROM), a Programmable ROM (PROM), an Erasable PROM (EPROM), an Electrically EPROM (EEPROM), or a flash memory. The volatile memory can be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synchlink DRAM (SLDRAM), and a Direct Rambus RAM (DRRAM). The memory 509 in the embodiments of this application includes but is not limited to these and any other suitable types of memories.

The processor 510 may include one or more processing units. In some embodiments, an application processor and a modem processor may be integrated in the processor 510. The application processor primarily processes operations involving an operating system, user interfaces, application programs, and the like. The modem processor primarily processes radio communication signals, for example, being a baseband processor. For example, it can be understood that the modem processor may be not integrated in the processor 510.

The processor 510 may be configured to determine the sampling rate, and is further configured to determine the feature sequence set matching with the sampling rate from a plurality of feature sequence sets based on the sampling rate. The radio frequency unit 501 may be configured to monitor the wake-up signal based on the first feature sequence in the feature sequence set.

According to the terminal provided in this embodiment of this application, the terminal determines a sampling rate, determines a feature sequence set matching the sampling rate from a plurality of feature sequence sets based on the sampling rate; and monitors a wake-up signal based on a first feature sequence in the feature sequence set. Because the terminal can determine the feature sequence set matching the sampling rate from the plurality of feature sequence sets, this helps the terminal to detect the wake-up signal and be correctly woken up, thus improving communication performance.

The terminal 500 provided in this embodiment of this application is capable of implementing the processes of the wake-up signal detection method embodiments, with the same technical effects achieved. To avoid repetition, details are not described herein again.

An embodiment of this application further provides a readable storage medium, where a program or instructions are stored in the readable storage medium. When the program or the instructions are executed by a processor, the processes of the foregoing embodiment of the wake-up signal detection method can be implemented, with the same technical effects achieved. To avoid repetition, details are not described herein again.

The processor is a processor in the terminal described in the foregoing embodiments. The readable storage medium includes a computer-readable storage medium, for example, a computer read only memory ROM, a random access memory RAM, a magnetic disk, or an optical disc.

An embodiment of this application further provides a chip, where the chip includes a processor and a communication interface. The communication interface is coupled to the processor, and the processor is configured to run a program or instructions to implement the processes of the embodiments of the wake-up signal detection method, with the same technical effects achieved. To avoid repetition, details are not described herein again.

It should be understood that the chip mentioned in the embodiments of this application may also be referred to as a system-level chip, a system chip, a chip system, a system-on-chip, or the like.

An embodiment of this application further provides a computer program/program product, where the computer program/program product is stored in a storage medium, and when being executed by at least one processor, the computer program/program product is configured to implement the processes of the embodiments of the wake-up signal detection method, with the same technical effects achieved. To avoid repetition, details are not repeated herein.

An embodiment of this application further provides a wake-up signal detection system, which includes a terminal and a network-side device, where the terminal can be configured to execute the steps of the wake-up signal detection method for sounding reference signals.

It should be noted that in this specification, the term “include”, “comprise”, or any of their variants are intended to cover a non-exclusive inclusion, so that a process, a method, an article, or an apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element. Furthermore, it should be noted that the scope of the methods and apparatuses in the embodiments of this application is not limited to performing the functions in the order shown or discussed, but may also include performing the functions in a substantially simultaneous manner or in a reverse order depending on the functions involved. For example, the described method may be performed in an order different from the order described, and steps may be added, omitted, or combined. In addition, features described with reference to some examples may be combined in other examples.

According to the description of the foregoing implementations, persons skilled in the art can clearly understand that the method in the foregoing embodiments may be implemented by software in combination with a necessary general hardware platform. Certainly, the method in the foregoing embodiments may, for example, be implemented by hardware. However, in many cases, the former is a preferred implementation. Based on such an understanding, the technical solutions of this application essentially or the part contributing to the prior art may be implemented in a form of a computer software product. The computer software product is stored in a storage medium (such as a ROM/RAM, a magnetic disk, or an optical disc), and includes several instructions for instructing a terminal (which may be a mobile phone, a computer, a server, a network device, or the like) to perform the methods described in the embodiments of this application.

The foregoing describes the embodiments of this application with reference to the accompanying drawings. However, this application is not limited to the foregoing specific implementations. These specific implementations are merely illustrative rather than restrictive. Inspired by this application, persons of ordinary skill in the art may develop many other forms without departing from the essence of this application and the protection scope of the claims, and all such forms shall fall within the protection scope of this application.

What is claimed is:

1. A wake-up signal detection method, comprising:
determining, by a receiving end, a sampling rate;
determining, by the receiving end, a feature sequence set matching the sampling rate from a plurality of feature sequence sets based on the sampling rate; and
monitoring, by the receiving end, a wake-up signal based on a first feature sequence in the feature sequence set.

2. The wake-up signal detection method according to claim 1, wherein the feature sequence set comprises a plurality of feature sequences, and each feature sequence in the plurality of feature sequences meets a requirement of maximizing a peak-to-side lobe ratio or a requirement of minimizing a maximum sidelobe value.

3. The wake-up signal detection method according to claim 1, wherein the plurality of feature sequence sets respectively correspond to different sampling rates.

4. The wake-up signal detection method according to claim 1, wherein the determining, by the receiving end, the sampling rate comprises:
determining, by the receiving end, the sampling rate from a sampling rate set; wherein the sampling rate set comprises a plurality of sampling rates.

5. The wake-up signal detection method according to claim 4, wherein the determining, by the receiving end, the sampling rate from the sampling rate set comprises:
determining, by the receiving end, the sampling rate from the sampling rate set based on at least one of the following:
receiving sensitivity of the receiving end;
strength of a signal received by the receiving end;
quality of a beacon signal received by the receiving end; or
a power consumption requirement.

6. The wake-up signal detection method according to claim 4, wherein a sampling rate in the sampling rate set is a divisor or multiple of a sampling rate used for sending a wake-up signal by a sending end.

7. The wake-up signal detection method according to claim 1, further comprising:
determining, by the receiving end, the first feature sequence from the feature sequence set based on a feature value.

8. The wake-up signal detection method according to claim 7, wherein the feature value is determined by the receiving end based on identification information of the receiving end, or indicated by a sending end.

9. A communication device, comprising a processor and a memory storing instructions, wherein the instructions, when executed by the processor, cause the processor to perform operations comprising:
determining a sampling rate;
determining a feature sequence set matching the sampling rate from a plurality of feature sequence sets based on the sampling rate; and
monitoring a wake-up signal based on a first feature sequence in the feature sequence set.

10. The communication device according to claim 9, wherein the feature sequence set comprises a plurality of feature sequences, and each feature sequence in the plurality of feature sequences meets a requirement of maximizing a peak-to-side lobe ratio or a requirement of minimizing a maximum sidelobe value.

11. The communication device according to claim 9, wherein the plurality of feature sequence sets respectively correspond to different sampling rates.

12. The communication device according to claim 9, wherein the determining the sampling rate comprises:
determining the sampling rate from a sampling rate set, wherein the sampling rate set comprises a plurality of sampling rates.

13. The communication device according to claim 9, wherein the operations performed by the processor further comprises:
determining the first feature sequence from the feature sequence set based on a feature value.

14. The communication device according to claim 13, wherein the feature value is determined by the receiving end based on identification information of the receiving end, or indicated by a sending end.

15. A non-transitory computer-readable storage medium storing instructions that, when executed by a processor, cause the processor to perform operations comprising:
determining a sampling rate;
determining a feature sequence set matching the sampling rate from a plurality of feature sequence sets based on the sampling rate; and
monitoring a wake-up signal based on a first feature sequence in the feature sequence set.

16. The non-transitory computer-readable storage medium according to claim 15, wherein the feature sequence set comprises a plurality of feature sequences, and each feature sequence in the plurality of feature sequences meets a requirement of maximizing a peak-to-side lobe ratio or a requirement of minimizing a maximum sidelobe value.

17. The non-transitory computer-readable storage medium according to claim 15, wherein the plurality of feature sequence sets respectively correspond to different sampling rates.

18. The non-transitory computer-readable storage medium according to claim 15, wherein the determining the sampling rate comprises:
determining the sampling rate from a sampling rate set, wherein the sampling rate set comprises a plurality of sampling rates.

19. The non-transitory computer-readable storage medium according to claim 15, wherein the operations performed by the processor further comprises:
determining the first feature sequence from the feature sequence set based on a feature value.

20. The non-transitory computer-readable storage medium according to claim 19, wherein the feature value is determined by the receiving end based on identification information of the receiving end, or indicated by a sending end.
